(19) United States
(12) Patent Application Publication
(10) Pub. No.: US 2026/0177119 A1
(43) Pub. Date: Jun. 25, 2026

(54) BRAKE DEVICE FOR VEHICLE

(71) Applicant: HYUNDAI MOBIS CO., LTD., Seoul (KR)

(72) Inventor: Byeong Jin CHOI, Yongin-si (KR)

(73) Assignee: HYUNDAI MOBIS CO., LTD., Seoul (KR)

(21) Appl. No.: 19/286,952

(22) Filed: Jul. 31, 2025

(30) Foreign Application Priority Data
Dec. 23, 2024 (KR) 10-2024-0194329

(51) Int. Cl. F16D 65/16; F16D 121/24; F16D 125/40; F16H 25/08; F16H 25/22

(52) U.S. Cl. CPC F16D 65/16; F16H 25/08; F16H 25/22; F16D 2121/24; F16D 2125/40

(57) ABSTRACT

A brake device for a vehicle includes a cylinder part, a motor part that generates rotational power, a screw shaft that is disposed inside the cylinder part, receives the rotational power of the motor part, and is axially rotated, a nut part that is coupled to the screw shaft and reciprocates in an axial direction of the screw shaft according to the rotation of the screw shaft, a sleeve part that is disposed between the cylinder part and the screw shaft, a piston part that is coupled to the nut part and includes a head portion reciprocating inside the sleeve part according to reciprocating movement of the nut part, a bearing part that is disposed inside the cylinder part and coupled to the screw shaft, and a reaction force part that has a first side supported on the cylinder part and a second side in contact with the sleeve part, presses the sleeve part toward the bearing part, and is capable of contacting the head portion.

### CROSS-REFERENCE TO RELATED APPLICATION

This application claims the benefit under 35 U.S.C. § 119 (a) of priority to Korean Patent Application No. 10-2024-0194329 filed on Dec. 23, 2024, in the Korean Intellectual Property Office, the entire disclosure of which is incorporated herein by reference for all purposes.

### BACKGROUND

### 1. Technical Field

Exemplary embodiments of the present disclosure relate to a brake device for a vehicle, and more particularly, to a brake device for a vehicle capable of converting rotational motion of a screw shaft by rotational force of a motor part into linear motion of a piston part.

### 2. Related Art

In general, due to the characteristics of an electric brake device for a vehicle, a device that generates a braking fluid pressure by converting the rotational motion of a motor into the linear motion of a piston in a cylinder is required.

As the device for converting the rotational motion of a motor into the linear motion, a ball screw device including a screw shaft that receives the rotational power of the motor and rotates, a nut that is connected to the screw shaft via balls and moves in an axial direction of the screw shaft, and a piston that is connected to the nut and pressurizes working fluid in the cylinder is applied to the electric brake device.

In the past, there was no reaction structure for compensating for assembly tolerances during assembly between a cylinder part, a sleeve part, and a bearing part. This causes a problem in that impact noise was generated by the movement of the sleeve part and the bearing part. In addition, there was a problem in that impact noise was generated between a piston part and the cylinder part when the piston part moved toward the motor part for zero point adjustment.

The background technology of the present disclosure is disclosed in Korean Patent Publishment No. 10-2021-0064367 (published on Jun. 2, 2021, entitled “Hydraulic part for hydraulic vehicle braking system”).

### SUMMARY

Various embodiments are directed to a brake device for a vehicle capable of compensating for assembly tolerance of a sleeve part and reducing impact noise when a piston part returns to an initial position.

Various embodiments are directed to a brake device for a vehicle capable of reducing impact or impact noise generated when a piston part returns to an initial position inside a cylinder part.

In an embodiment of the present disclosure, a brake device may include a cylinder part, a motor part that generates rotational power, a screw shaft that is disposed inside the cylinder part, receives the rotational power of the motor part, and is axially rotated, a nut part that is coupled to the screw shaft and reciprocates in an axial direction of the screw shaft according to the rotation of the screw shaft, a sleeve part that is disposed between the cylinder part and the screw shaft, a piston part that is coupled to the nut part and includes a head portion reciprocating inside the sleeve part according to reciprocating movement of the nut part, a bearing part that is disposed inside the cylinder part and coupled to the screw shaft, and a reaction force part that has a first side supported on the cylinder part and a second side in contact with the sleeve part, presses the sleeve part toward the bearing part, and is capable of contacting the head portion.

The reaction force part may be disposed in a path through which the head portion moves backward inside the cylinder part.

The reaction force part may be in contact with the head portion when the head portion moves backward and returns to an initial position.

The reaction force part may include an elastically deformable material.

The reaction force part my include a reaction force body formed in a ring shape, and a reaction force protrusion protruding from the reaction force body toward the sleeve part.

A plurality of reaction force protrusions may be disposed on one side of the reaction body to be spaced apart from each other, and a working fluid may flow through spaces between the reaction force protrusions.

The reaction force part may include a rubber material.

The reaction force part may include a wave spring.

The wave spring may have a wavy shape or a corrugated shape.

According to the present disclosure, the assembly tolerance of the sleeve part can be compensated, and the occurrence of impact noise due to relative movement of the sleeve part or the bearing part can be blocked.

In addition, according to the present disclosure, the impact or impact noise generated when the piston part returns to the initial position inside the cylinder part can be reduced.

### BRIEF DESCRIPTION OF THE DRAWINGS

FIG. 1 is a cross-sectional view illustrating a brake device for a vehicle according to an embodiment of the present disclosure.

FIG. 2 is a perspective view of a cylinder part according to an embodiment of the present disclosure, viewed from one direction.

FIG. 3 is a perspective view of the cylinder part of FIG. 2, viewed from another direction.

FIG. 4 is a cross-sectional view schematically illustrating a brake device for a vehicle according to an embodiment of the present disclosure.

FIG. 5 is a perspective view illustrating a reaction force part according to an embodiment of the present disclosure.

FIG. 6 is a perspective view illustrating a state in which the reaction force part of FIG. 5 is mounted.

FIG. 7 is a perspective view illustrating a modification example of the reaction force part according to an embodiment of the present disclosure.

FIG. 8 is a perspective view illustrating a state in which the reaction force part of FIG. 7 is mounted.

FIG. 9 illustrates an operating state in which a piston part advances inside a cylinder part in a brake device for a vehicle according to an embodiment of the present disclosure.

FIG. 10 illustrates an operating state in which a piston part retreats inside a cylinder part in a brake device for a vehicle according to an embodiment of the present disclosure.

### DETAILED DESCRIPTION

Hereinafter, a brake device for a vehicle according to the present disclosure is described in detail below with reference to the accompanying drawings through various exemplary embodiments. It should be considered that the thickness of each line or the size of each component in the drawings may be exaggeratedly illustrated for clarity and convenience of description. In addition, terms to be described below have been defined by taking into consideration their functions in the present disclosure, and may be different depending on a user or operator's intention or practice. Accordingly, such terms should be interpreted based on the overall contents of this specification.

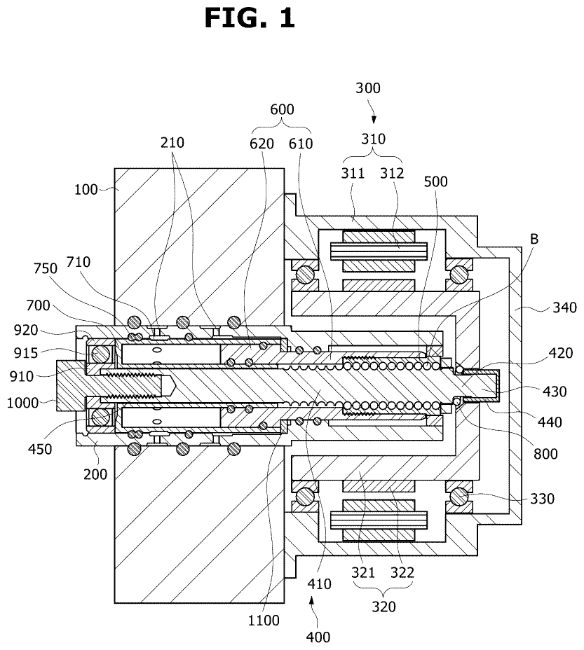

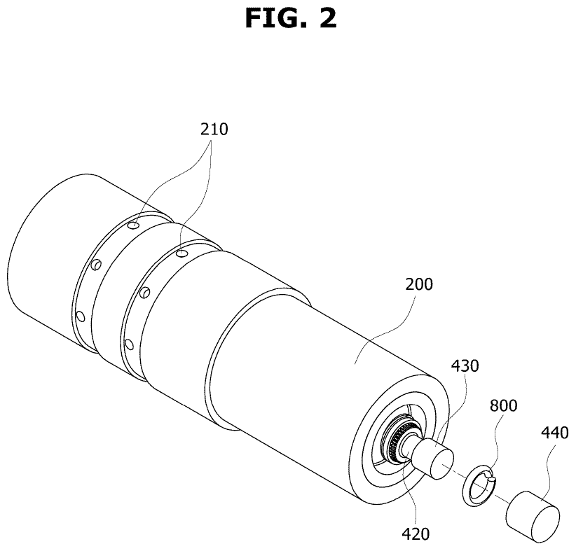

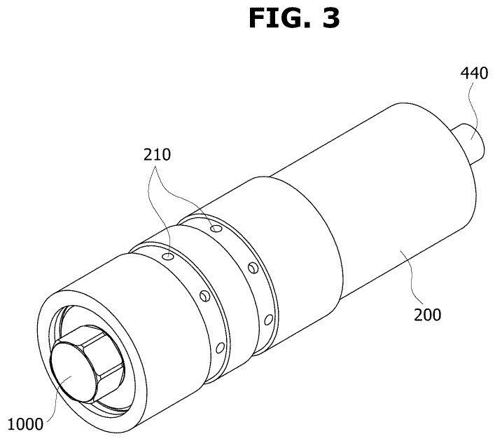

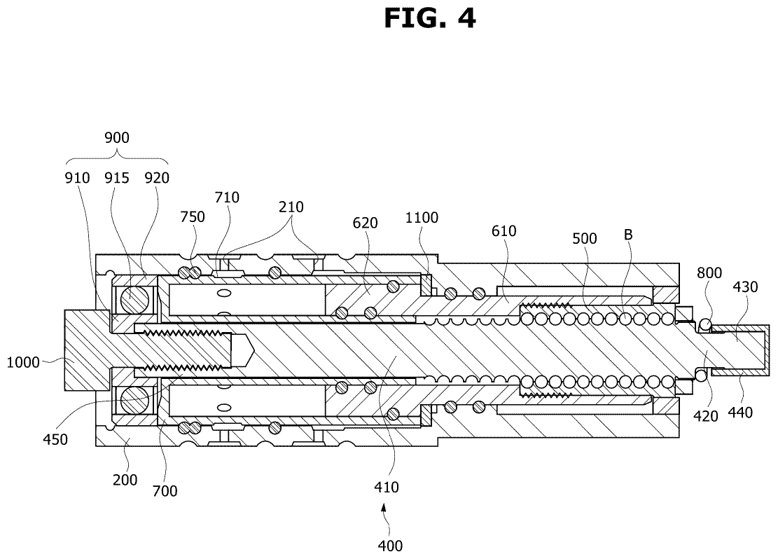

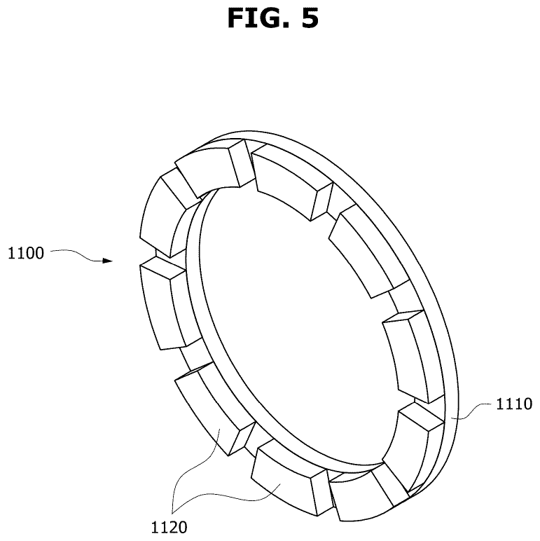

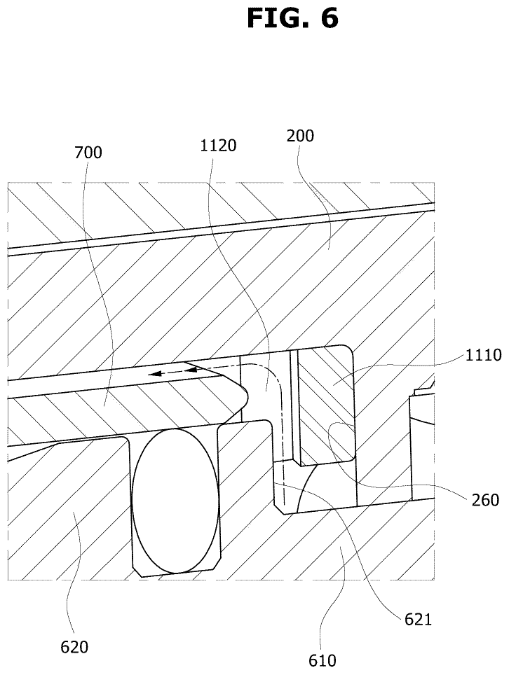

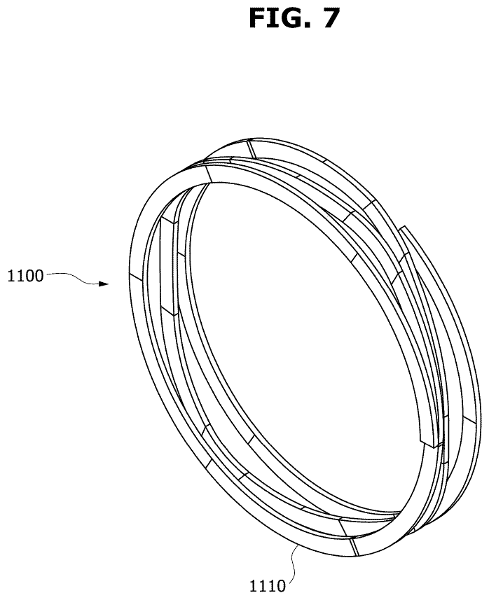

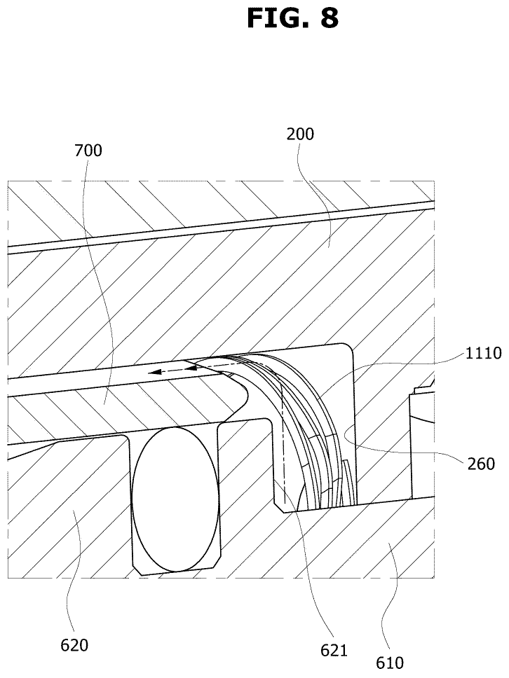

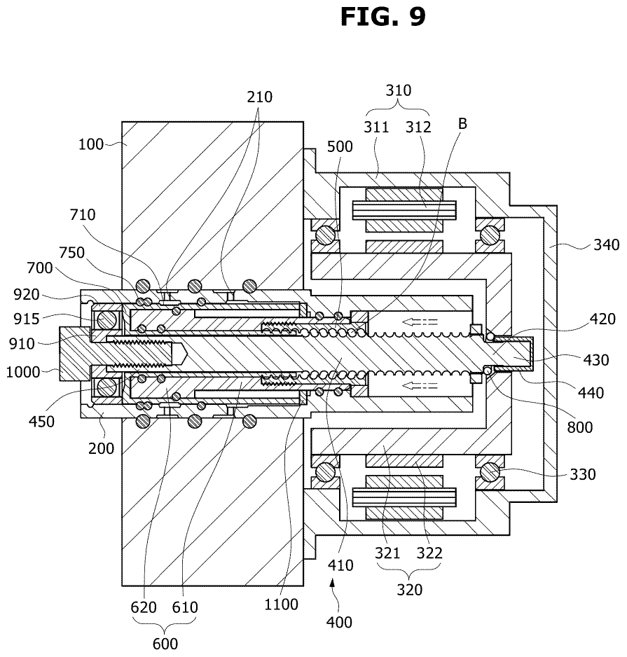

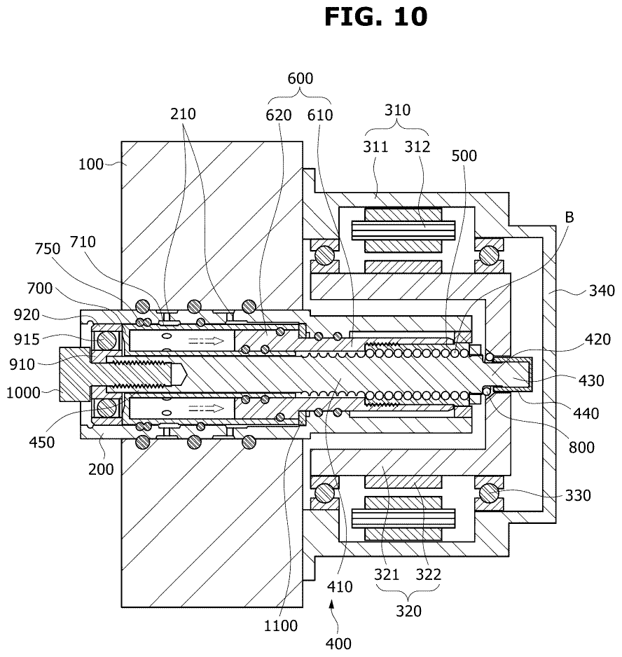

FIG. 1 is a cross-sectional view illustrating a brake device for a vehicle according to an embodiment of the present disclosure. FIG. 2 is a perspective view of a cylinder part according to an embodiment of the present disclosure, viewed from one direction. FIG. 3 is a perspective view of the cylinder part of FIG. 2, viewed from another direction. FIG. 4 is a cross-sectional view schematically illustrating the brake device for a vehicle according to an embodiment of the present disclosure. FIG. 5 is a perspective view illustrating a reaction force part according to an embodiment of the present disclosure. FIG. 6 is a perspective view illustrating a state in which the reaction force part of FIG. 5 is mounted. FIG. 7 is a perspective view illustrating a modification example of the reaction force part according to an embodiment of the present disclosure. FIG. 8 is a perspective view illustrating a state in which the reaction force part of FIG. 7 is mounted. FIG. 9 illustrates an operating state in which a piston part advances inside the cylinder part in the brake device for a vehicle according to an embodiment of the present disclosure. FIG. 10 illustrates an operating state in which the piston part retreats inside the cylinder part in the brake device for a vehicle according to an embodiment of the present disclosure.

Referring to FIG. 1 to FIG. 4, the brake device for a vehicle according to an embodiment of the present disclosure includes a cylinder part 200, a motor part 300, a screw shaft 400, a nut part 500, a piston part 600, a sleeve part 700, and a reaction force part 1100, which is described in detail as follows.

The cylinder part 200 is disposed inside the housing part 100 to support torque generated when hydraulic pressure is formed according to the reciprocating movement of the piston part 600. The housing part 100 according to the present embodiment may be formed in a hollow shape in which an inner space is provided, and may be press-fitted to the cylinder part 200.

The housing part 100 is provided outside the cylinder part 200 (left side of FIG. 1). The cylinder part 200 may be assembled so that concentricity is regulated in the housing part 100.

The cylinder part 200 is formed in a hollow shape. In a space (left side based on FIG. 1) inside the cylinder part 200, the sleeve part 700 having an operation section provided therein may is disposed so that hydraulic pressure is formed by pressing the piston part 600.

The motor part 300 is connected to the cylinder part 200 and various types of driving devices may be used within a technical idea that generates rotational power. The motor part 300 transmits rotational power (torque) to the screw shaft 400.

The motor part 300 includes a fixing part 310, a motor rotating part 320, and a motor bearing part 330.

The fixing part 310 is fixed to the housing part 100 and may be formed in various shapes within a technical idea in which a magnetic force is changed by the supply of power.

The fixing part 310 includes a fixing frame 311 fixed to one side (right side of FIG. 1) of the housing part 100, and a stator 312 that is installed on an inner surface of the fixing frame 311 facing the motor rotating part 320 and generates a magnetic force.

The fixing frame 311 is connected to one side of the housing part 100, and the motor rotating part 320 is rotatably installed inside the fixing frame 311.

The stator 312, which is an electromagnet, is installed in a circumferential direction on an inner surface of the fixing frame 311, and magnetic flux is changed by a control signal from a control unit (not shown) to rotate the motor rotating part 320.

The motor rotation part 320 is connected to the screw shaft 400 to be rotated together with the screw shaft 400, and may be modified into various shapes within the technical idea that rotates according to the change in magnetic force of the fixing part 310.

The motor rotating part 320 is rotatably installed inside the fixing frame 311. A cross section of the motor rotating part 320 is formed in an approximately “C” shape, and may be formed in a hollow shape.

The motor rotating part 320 includes a rotating frame 321 installed in a shape surrounding one side (right side of FIG. 1) of the cylinder part 200, and a rotor 322 installed on an outer surface of the rotating frame 321 facing the fixing part 310 and having a magnetic force.

A spline engaged with the screw shaft 400 may be formed on the rotating frame 321, specifically, on an inner surface of the rotating frame 321.

The motor bearing part 330 is installed between the fixing part 310 and the motor rotation part 320 to reduce friction generated when the motor rotation part 320 rotates. The rotor 322 including a plurality of magnets installed in the circumferential direction of the rotating frame 321 is rotated together with the rotating frame 321 by a change in a magnetic force of the stator 312.

The cover member 340 fixed to the fixing frame 311 is installed in a shape surrounding the outer end of the rotating frame 321 to block inflow of foreign substances.

The screw shaft 400 is provided inside the cylinder part 200. The screw shaft 400 is inserted into the cylinder part 200 in a longitudinal direction (a left-right direction based on FIG. 1) and is axially coupled to the cylinder part 200. The central axis of the cylinder part 200 and the central axis of the screw shaft 400 may coincide with each other.

The screw shaft 400 is fixed to a bearing part 900 by a support part 1000. The support part 1000 rotatably supports the screw shaft 400.

The screw shaft 400 includes a screw body portion 410, a neck portion 420, a power transmission portion 430, and a coupling portion 450.

The screw body portion 410 is rotatably installed inside the cylinder part 200, and a spiral gear may be disposed in the longitudinal direction of the screw shaft 400. The screw body portion 410 may be located inside the rotating frame 321 of the motor part 300.

The neck portion 420 protrudes from an outer surface of a rotation center of the screw body portion 410 toward the first side (right side based on FIG. 1), and has a diameter smaller than that of the screw body portion 410.

The power transmission portion 430 extends from a free end of the neck portion 420 toward the first side (right side based on FIG. 1) and has a diameter greater than that of the neck portion 420.

A spline may be formed on an outer surface of the power transmission portion 430 facing the rotating frame 321 in the circumferential direction. Therefore, in the absence of the cover portion 440 to be described later, the rotating frame 321 and the power transmission portion 430 may be engaged with each other to perform power transmission.

The screw shaft 400 further includes the cover portion 440. The cover portion 440 is disposed to surround the neck portion 420 and the power transmission portion 430. The cover portion 440 is interposed between the power transmission portion 430 and the rotating frame 321 to prevent generation of metallic rattle noise.

A spline may be formed in the outer surface of the cover portion 440 along the circumferential direction of the cover portion 440 to be engaged with the rotating frame 321. An outer shape of the cover portion 440 may be the same as the outer shape of the power transmission portion 430.

A spline may be formed on an outer surface of the power transmission portion 430 facing the cover portion 440 in the circumferential direction. Therefore, the cover portion 440 and the power transmission portion 430 are engaged with each other to perform power transmission.

The coupling portion 450 extends from an outer surface of a rotation center of the screw body portion 410 toward a second side (left side based on FIG. 1), and is rotatably coupled to the bearing part 900. The coupling portion 450 is forcibly press-fitted to the bearing part 900. The coupling portion 450 has a diameter that is the same as or smaller than that of the screw body portion 410.

The nut part 500 is located inside the rotating frame 321 of the motor part 300 and is disposed inside the cylinder part 200.

The nut part 500 is coupled to the outer surface of the screw shaft 400 via ball members B.

The screw shaft 400 penetrates and is coupled to the nut part 500. Because the ball members B are disposed between the inner surface of the nut part 500 and the spiral gear formed on the outer surface of the screw body portion 410, the rotational motion of the screw shaft 400 can be converted into linear motion through the nut part 500.

The nut part 500 may include an anti-rotation protrusion (not shown) formed on an outer surface thereof, and the cylinder part 200 may have a moving groove (not shown) formed on an inner surface thereof.

The rotation of the anti-rotation protrusion of the nut part 500 is blocked by the moving groove when the screw shaft 400 rotates, so that the nut part 500 is not rotated. Therefore, the rotational motion of the screw shaft 400 may be converted into the linear motion of the nut part 500 by the anti-rotation protrusion and the moving groove.

The nut part 500 reciprocates in the axial direction of the screw shaft 400 along the rotation direction of the screw shaft 400. For example, when the screw shaft 400 rotates in a first direction, the nut part 500 may be moved forward, and when the screw shaft 400 rotates in a second direction opposite to the first direction, the nut part 500 may be moved backward.

The piston part 600 is coupled to surround the outer side of the nut part 500. The piston part 600 may be linked to the reciprocating movement of the nut part 500 and may move in the longitudinal direction of the cylinder part 200.

The piston part 600 includes a rod portion 610 and a head portion 620.

The rod portion 610 has a hollow shape and is positioned inside the rotating frame 321 of the motor part 300. The outer surface of the nut part 500 and the inner surface of the rod portion 610 may be screwed.

The head portion 620 is integrally formed with the rod portion 610. An external diameter of the head portion 620 is greater than an external diameter of the rod portion 610.

The head portion 620 has a ring shape, is located inside the housing part 100, and moves the working fluid inside the sleeve part 700 in a direction toward the port 210 while reciprocating inside the sleeve part 700. Accordingly, the cylinder part 200 can form a double-acting hydraulic pressure according to the reciprocating movement of the piston part 600.

The sleeve part 700 is located inside the housing part 100 and is disposed inside the cylinder part 200. The sleeve part 700 induces the piston part 600 inserted therein to be moved.

The sleeve part 700 is disposed to surround the head portion 620 of the piston part 600.

The port 210 through which the working fluid moves may be disposed on an outer surface of the cylinder part 200, where the sleeve part 700 is disposed. The port 210 may be provided at a plurality of points in the longitudinal direction of the cylinder part 200. The working fluid that moves according to the movement of the piston part 600 moves through the port 210 and can implement the required braking pressure.

Cut-off holes 710 are disposed on an outer surface of the sleeve part 700 to communicate with the port 210.

A plurality of cutoff holes 710 may be disposed to be spaced apart from each other in the circumferential direction of the sleeve part 700. Accordingly, the working fluid inside the sleeve part 700 may be discharged in the radial direction of the piston part 600.

Referring to FIG. 1 to FIG. 6, the reaction force part 1100 has a first side supported by the cylinder part 200 and a second side in contact with the sleeve part 700 to press the sleeve part 700 toward the bearing part 900.

The first side of the reaction force part 1100 is in contact with and supported by an inner wall portion 260 of the cylinder part 200, and the second side opposite to the first side is in contact with and supported by an end portion of the sleeve part 700. A gap generated in the process of assembling the sleeve part 700 to the cylinder part 200 may be filled by arranging the reaction force part 1100.

Even when there is a gap between the sleeve part 700 and the inner wall portion 260 of the cylinder part 200, because the reaction force part 1100 is disposed in the gap, the sleeve part 700 can be elastically supported by the reaction force part 1100 to be in close contact with the bearing part 900. Accordingly, the assembly gap or assembly tolerance between the cylinder part 200 and the sleeve part 700 is compensated by the reaction force part 1100, so that the occurrence of a strike sound caused by the relative movement of the sleeve part 700 or the bearing part 900 can be prevented.

The reaction force part 1100 may be in contact with the head portion 620 of the piston part 600. In a process in which the piston part 600 is retreated and returned to an initial position toward the motor part 300 (refer to FIG. 10), a rear end 621 of the head portion 620 is in contact with the reaction force part 1100 before the piston part 600 collides with the inner wall portion 260 of the cylinder part 200. Accordingly, the head portion 620 can be prevented from directly colliding with the inner wall portion 260 of the cylinder part 200 when the piston part 600 returns to the initial position for the adjustment of O point, so that the strike sound or impact generated due to the direct collision can be prevented.

The reaction force part 1100 may be disposed in a path in which the head portion 620 retreats. Because the reaction force part 1100 is disposed on the retreat movement path of the head portion 620, the retreat movement of the head portion 620 can be limited by the reaction force part 1100.

The reaction force part 1100 is disposed between the sleeve part 700 and the inner wall portion 260 of the cylinder part 200, and protrudes to the retreat movement path of the head portion 620.

The reaction force part 1100 may include an elastically deformable material. Accordingly, the reaction force part 1100 can elastically support the bearing part 900 such that the sleeve part 700 is in close contact with the bearing part 900, and can buffer noise such as impact and/or strike sound due to contact with the head portion 620 when the head portion 620 returns to the initial position.

Referring to FIG. 5 and FIG. 6, the reaction force part 1100 include a reaction force body 1110 and reaction force protrusions 1120.

The reaction force body 1110 is disposed in a ring shape, and the reaction force protrusions 1120 protrude toward the sleeve part 700. The reaction force body 1110 is disposed in a ring shape along the inner circumference of the cylinder part 200 and disposed between the sleeve part 700 and the inner wall portion 260 of the cylinder part 200.

A plurality of reaction force protrusions 1120 are disposed on a surface of the reaction force body 1110 to be spaced apart from each other. The reaction force protrusions 1120 are disposed at the same rotation interval on the surface of the reaction force body 1110, which faces the sleeve part 700. An end of the sleeve part 700 is in contact with the reaction force protrusion 1120, and the inner wall portion 260 of the cylinder part 200 is in contact with the reaction force body 1110.

Because the plurality of reaction force protrusions 1120 are disposed to be spaced apart from each other, separation spaces exist between neighboring reaction force protrusions 1120. The working fluid in the sleeve part 700 may move in a direction toward the port 210 through the separation spaces. An arrow in FIG. 6 indicates a movement path of the working oil. Accordingly, the cylinder part 200 may form the double-acting hydraulic pressure according to the reciprocating movement of the piston part 600.

The reaction force body 1110 and the reaction force protrusions 1120 may include a rubber material. The reaction force body 1110 and the reaction force protrusions 1120 may be integrally formed.

Referring to FIG. 7 and FIG. 8, the reaction force part 1100 includes a wave spring 1110.

The wave spring 1110 may have a wavy or corrugated shape. Therefore, even when the wave spring 1110 is compressed and deformed, the wavy portion or the corrugated portion of the wave spring 1110 is not completely unfolded, and thus, a space of the wave spring 1110 still exists around the wavy portion or the corrugated portion. Through the space inside the wave spring 1110, the working fluid inside the sleeve part 700 may be moved in a direction toward the port 210.

The wave spring 1110 may be formed of one or more rings having a wavy or corrugated shape, or may be formed in a shape in which one or more rings having a wavy or corrugated shape are wound. The wave spring 1110 may be formed by connecting or overlapping a plurality of rings having a wavy or corrugated shape.

The wave spring 1110 may be formed of one or more plates having a wavy or corrugated shape, or may be formed in a shape in which one or more plates having a wavy or corrugated shape are wound. The wave spring 1110 may be formed by connecting or overlapping a plurality of plates having a wavy or corrugated shape. Therefore, the shape of the wave spring 1110 is not limited to the shape shown in FIG. 7. The wave spring 1110 may include a metal material.

The wave spring 1110 may be formed in a ring shape along the inner circumference of the cylinder part 200 and disposed between the sleeve part 700 and the inner wall portion 260 of the cylinder part 200.

Even when the head portion 620 returns to the initial position and the wave spring 1110 is compressed, a space exists in the wave spring 1110. Accordingly, the working fluid inside the sleeve part 700 can move in the direction toward the port 210 through the space inside the wave spring 1110. An arrow in FIG. 8 indicates the movement path of the working fluid. Accordingly, the cylinder part 200 can form a double-acting hydraulic pressure according to the reciprocating movement of the piston part 600.

A sealing part 750 and an O-ring part (not shown) are disposed on left and right sides of the cut-off holes 710, respectively, in the sleeve part 700.

The sealing part 750 may be disposed on the inner wall of the cylinder part 200 to be spaced apart from the cutoff holes 710 in the forward movement direction of the piston part 600 (the left movement direction based on FIG. 9), and the O-ring part may be disposed on the inner wall of the cylinder part 200 to be spaced apart from the cutoff hole 710 in the retreat movement direction of the piston part 600 (the right movement direction based on FIG. 10).

The sealing part 750 is installed on an inner wall of the cylinder part 200 and seals the space between the cylinder part 200 and the sleeve part 700. The sealing part 750 is in contact with the cylinder part 200 and the sleeve part 700 and in contact at a plurality of points to seal the space between the cylinder part 200 and the sleeve part 700 at multiple points. Accordingly, even when fine behavior occurs in the sleeve part 700 in the axial direction, the sealing part 750 can seal the space between the cylinder part 200 and the sleeve part 700. The sealing part 750 may include an elastically deformable material.

The sealing part 750 may have an overall cross-sectional shape of an “8” shape or a peanut shape. The length of the sleeve part 700 in the longitudinal direction (left and right directions based on FIG. 1) may be longer than the length of the sleeve part 700 in the radial direction (vertical direction based on FIG. 1).

The brake device for a vehicle according to the present embodiment includes a vibration reduction part 800. The vibration reduction part 800 is supported by the screw shaft 400 at a first side (left side based on FIG. 1) and a second side (right side based on FIG. 1) by the motor part 300. Accordingly, the vibration reduction part 800 can suppress the neck portion 420 of the screw shaft 400 from vibrating greatly while being deviated from the central axis of the screw shaft 400 in the rotating frame 321 of the motor part 300.

The neck portion 420 of the screw shaft 400 is in indirect contact with the rotating frame 321 via the vibration reduction part 800. Accordingly, when the brake device for a vehicle is operated, the neck portion 420 of the screw shaft 400 has a reduced relative displacement with respect to the rotating frame 321, so that the amplitude of the screw shaft 400 can be reduced.

The vibration reduction part 800 may be elastically deformed while being supported by the screw shaft 400 and the motor part 300. Accordingly, when the screw shaft 400 is shaken, the vibration reduction part 800 may be elastically deformed and absorb the vibration of the screw shaft 400 or the impact caused by the vibration.

The vibration reduction part 800 may be a spiral coil. The vibration reduction part 800 may be formed in a discontinuous ring shape. That is, as shown in FIG. 2, the vibration reduction part 800 may be formed in a ring shape having one side of an outer circumferential surface open.

The vibration reduction part 800 includes two ends, so that the vibration of the screw shaft 400 may be transmitted to the vibration reduction part 800 and then dispersed to the outside through the ends of the vibration reduction part 800. The second side of the vibration reduction part 800 may be disposed to be more spaced apart from the sleeve part 700 than the first side.

Referring to FIG. 1, a point where the vibration reduction part 800 is in contact with the screw shaft 400 and a point where the vibration reduction part 800 is in contact with the rotating frame 321 of the motor part 300 are disposed in an oblique direction. Therefore, the vibration reduction part 800 may buffer the vibration in all directions of 360 degrees with respect to the central axis of the screw shaft 400.

The vibration reduction part 800 may include a steel material. More specifically, the vibration reduction part 800 may be made of stainless steel. The vibration reduction part 800 may be a torsion spring or a distortion coil.

A first side of the vibration reduction part 800 may be in contact with and supported by a stepped portion of a connection portion between the screw body portion 410 and the neck portion 420. A second side of the vibration reduction part 800 may be in contact with and supported by the rotating frame 321 of the motor part 300. The second side of the vibration reduction part 800 may be in contact with and supported by the tapered surface of the rotating frame 321.

Because the screw shaft 400 is coupled to the nut part 500 via the ball members B, a certain amount of vibration is allowed to prevent performance degradation or jamming during operations. In the present embodiment, the vibration reduction part 800 is disposed in the space where the vibration of the screw shaft 400 occurs, so the vibration can be effectively reduced without restricting the degree of freedom of vibration of the screw shaft 400.

The vibration reduction part 800 may be disposed to surround the neck portion 420 of the screw shaft 400 not to interfere with the cover portion 440. The vibration reduction part 800 may be disposed not to contact an inner circumferential surface of the neck portion 420.

The brake device for a vehicle according to an embodiment of the present disclosure includes the bearing part 900. The bearing part 900 is located inside the housing part 100 and is provided at an inner end of the cylinder part 200.

The outer surface of the bearing part 900 and the outer surface of the sleeve part 700 may be disposed in contact with each other. The bearing part 900 is coupled to the screw shaft 400 to surround the coupling portion 450 of the screw shaft 400.

The bearing part 900 includes an inner wheel portion 910, bearing balls 915, and an outer wheel portion 920. The inner wheel portion 910 is installed in contact with the coupling portion 450 of the screw shaft 400, and the outer wheel portion 920 is installed in contact with the inner surface of the cylinder part 200.

The bearing part 900 supports a load in an axial direction of the screw shaft 400 when hydraulic pressure is formed in the cylinder part 200 by the piston part 600 that reciprocates in the axial direction of the screw shaft 400.

The brake device for a vehicle according to an embodiment of the present disclosure includes the support part 1000. The support part 1000 is provided inside the cylinder part 200. The support part 1000 is inserted into the coupling portion 450 and coupled to the screw shaft 400. The support part 1000 is screwed to the screw shaft 400. The bearing part 900 is fixed to the support part 1000. The support part 1000 rotatably supports the screw shaft 400. The support part 1000 may be a bolt.

An operation process of the brake device for a vehicle according to an embodiment of the present disclosure having the above-described configuration is described as follows.

Referring to FIG. 9, when the motor part 300 is operated and the rotational force is transmitted to the screw shaft 400, the screw shaft 400 is axially rotated in the first rotational direction inside the cylinder part 200, and the nut part 500 is moved forward along the screw shaft 400 toward the sleeve part 700.

When the nut part 500 is moved toward the sleeve part 700, the piston part 600 coupled to the nut part 500 moves forward in a straight line inside the cylinder part 200 in a direction the same as the moving direction of the nut part 500 to form a braking hydraulic pressure.

Referring to FIG. 10, when the motor part 300 is operated so that the screw shaft 400 is axially rotated in the second rotation direction, which is the reverse direction of the first rotation direction, the nut part 500 is moved backward along the screw shaft 400 in the opposite direction of the sleeve part 700.

When the nut part 500 is moved in an opposite direction to the sleeve part 700, the piston part 600 coupled to the nut part 500 may retreat in a straight line inside the cylinder part 200 in a direction the same as the moving direction of the nut part 500 and return to the initial position to form the braking hydraulic pressure. Accordingly, as the piston part 600 is moved forward and backward in the straight line in the cylinder part 200, the double-acting hydraulic pressure is formed.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A brake device for a vehicle, comprising:
a cylinder part;
a motor part that generates rotational power;
a screw shaft that is disposed inside the cylinder part configured to receive the rotational power of the motor part, and is axially rotated;
a nut part that is coupled to the screw shaft and reciprocates in an axial direction of the screw shaft according to the rotation of the screw shaft;
a sleeve part that is disposed between the cylinder part and the screw shaft;
a piston part that is coupled to the nut part and includes a head portion reciprocating inside the sleeve part according to reciprocating movement of the nut part;
a bearing part that is disposed inside the cylinder part and coupled to the screw shaft; and
a reaction force part that has a first side supported on the cylinder part and a second side in contact with the sleeve part, wherein the reaction force part is configured to press the sleeve part toward the bearing part and contact the head portion.

2. The brake device of claim 1, wherein the reaction force part is disposed in a path through which the head portion moves backward inside the cylinder part.

3. The brake device of claim 2, wherein the reaction force part is in contact with the head portion when the head portion moves backward and returns to an initial position.

4. The brake device of claim 3, wherein the reaction force part comprises an elastically deformable material.

5. The brake device of claim 4, wherein the reaction force part comprises:
a reaction force body formed in a ring shape; and
a reaction force protrusion protruding from the reaction force body toward the sleeve part.

6. The brake device of claim 5, wherein a plurality of reaction force protrusions are disposed on one side of the reaction force body to be spaced apart from each other, and
wherein a working fluid flows through spaces between the plurality of reaction force protrusions.

7. The brake device of claim 6, wherein the reaction force part comprises a rubber material.

8. The brake device of claim 4, wherein the reaction force part comprises a wave spring.

9. The brake device of claim 8, wherein the wave spring has a wavy shape or a corrugated shape.
